(19) United States
(12) Patent Application Publication
(10) Pub. No.: US 2026/0010844 A1
(43) Pub. Date: Jan. 8, 2026

(54) SCHEDULE PLANNING DEVICE

(71) Applicant: Hitachi, Ltd., Tokyo (JP)

(72) Inventor: Yuki Mori, Tokyo (JP)

(21) Appl. No.: 19/060,139

(22) Filed: Feb. 21, 2025

(30) Foreign Application Priority Data
Jul. 3, 2024 (JP) 2024-107557

(51) Int. Cl. G06Q 10/0631

(52) U.S. Cl. CPC G06Q 10/063112

(57) ABSTRACT

A schedule planning device includes a phase setting unit capable of setting a schedule creation phase to one of a first creation phase for improving work efficiency and a second creation phase for developing human resources, based on skill information of a plurality of workers for work to be assigned to workers included in a schedule, and a schedule planning unit that assigns the work to be assigned to a worker who can take charge of the work to be assigned and has a highest skill for the work to be assigned in a case where the first creation phase is set, and assigns the work to be assigned to a worker who can take charge of the work to be assigned and has a lowest skill for the work to be assigned in a case where the second creation phase is set.

### TECHNICAL FIELD

The present invention relates to a schedule planning device.

### BACKGROUND ART

Conventionally, in a project in which a large number of people participate, such as system operation work and production management, the entire schedule of the project is often centrally managed in a Gantt chart including progress management of task. For example, a schedule creator needs to perform work such as creation and change (update) of the schedule in consideration of various factors such as a due date, a budget, a priority of the task, a task assignment, past performance, and a progress status. Therefore, the schedule creation work is man-hour intensive work. In addition, in a case where the schedule creator changes the schedule or the like without taking man-hours by oneself, there is a possibility that the schedule creator cannot create a schedule plan suitable for constraint conditions.

Therefore, conventionally, various techniques for reducing the schedule creation work have been proposed (see, for example, PTL 1). PTL 1 discloses a simple schedule management tool for simply adjusting the schedule. In the simple schedule management tool disclosed in PTL 1, calculation is performed according to a specified pattern from data of an existing schedule and progress data, and start date and end date of each uncompleted work after a time point at which schedule adjustment is performed are obtained. Then, the schedule is adjusted on the basis of the obtained result, and schedule data is output.

### CITATION LIST

### Patent Literature

PTL 1: JP H10-312429 A

### SUMMARY OF INVENTION

### Technical Problem

Meanwhile, usually, at the time of schedule creation (planning), personnel are assigned to various works in consideration of, for example, productivity, work efficiency, and the like. However, in view of a problem of labor shortage in recent years, it is necessary to create the schedule in consideration of the perspective of not only productivity, work efficiency, and the like but also human resource development.

The present invention has been made to solve the above problems, and an object of the present invention is to provide a schedule planning technique capable of not only improving productivity, work efficiency, and the like but also developing human resources.

### Solution to Problem

In order to solve the above problems, the schedule planning device of the present invention includes a phase setting unit and a schedule planning unit. The phase setting unit can set a schedule creation phase to one of a first creation phase for the purpose of improving work efficiency and a second creation phase for the purpose of developing human resources, on the basis of skill information of a plurality of workers for work to be assigned to the workers included in the schedule. The schedule planning unit plans the schedule on the basis of the information on the work to be assigned input by a user and setting results in the phase setting unit. In a case where the first creation phase is set by the phase setting unit, the schedule planning unit assigns the work to be assigned to a worker who can take charge of the work to be assigned and has the highest skill for the work to be assigned. In addition, in a case where the second creation phase is set by the phase setting unit, the schedule planning unit assigns the work to be assigned to a worker who can take charge of the work to be assigned and has the lowest skill for the work to be assigned.

### Advantageous Effects of Invention

According to the present invention having the above configuration, for example, it is possible to plan a schedule that enables not only improvement in productivity, work efficiency, and the like but also human resource development.

### BRIEF DESCRIPTION OF DRAWINGS

FIG. 1 is a functional block configuration diagram of a schedule planning device according to an embodiment of the present invention.

FIG. 2 is a diagram illustrating a configuration example of schedule data for each worker stored in a data storage unit of the schedule planning device according to the embodiment of the present invention.

FIG. 3 is a diagram illustrating a configuration example of skill data for each work stored in the data storage unit of the schedule planning device according to the embodiment of the present invention.

FIG. 4 is a diagram illustrating a configuration example of project schedule data stored in the data storage unit of the schedule planning device according to the embodiment of the present invention.

FIG. 5 is a diagram illustrating an example of a display mode of a schedule planning result displayed on a schedule display unit of the schedule planning device according to the embodiment of the present invention.

FIG. 6 is a diagram illustrating an example of a display mode of a schedule creation screen displayed on the schedule display unit of the schedule planning device according to the embodiment of the present invention.

FIG. 7 is a hardware configuration diagram of the schedule planning device according to the embodiment of the present invention.

FIG. 8 is a diagram for describing an outline of a schedule planning processing performed by a conventional schedule planning device.

FIG. 9 is a diagram for describing an outline of a schedule planning processing performed by the schedule planning device according to the embodiment of the present invention.

FIG. 10 is a flowchart illustrating a procedure of the schedule planning processing performed by the schedule planning device according to the embodiment of the present invention.

FIG. 11 is a flowchart illustrating a procedure of schedule creation phase setting processing performed by the schedule planning device according to the embodiment of the present invention.

FIG. 12 is a flowchart illustrating a procedure of schedule creation processing in a normal phase performed by the schedule planning device according to the embodiment of the present invention.

FIG. 13 is a flowchart illustrating a procedure of schedule creation processing in a human resource development phase performed by the schedule planning device according to the embodiment of the present invention.

### DESCRIPTION OF EMBODIMENTS

Hereinafter, a schedule planning device according to an embodiment of the present invention will be specifically described with reference to the drawings.

### Functional Configuration of Schedule Planning Device

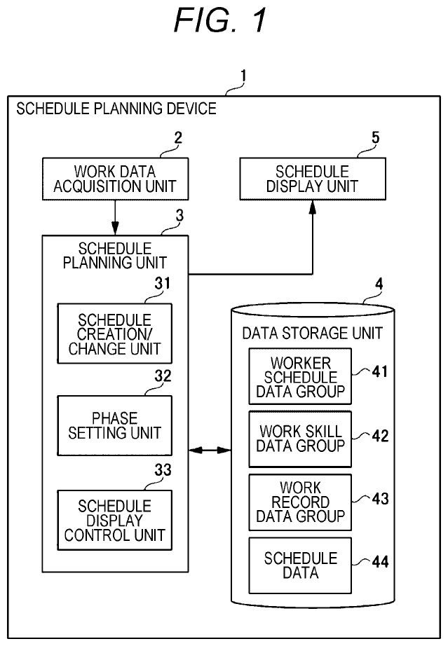

FIG. 1 is a functional block configuration diagram of the schedule planning device according to the embodiment of the present invention. Note that FIG. 1 illustrates only functional units related to processing of planning (creating and changing) an entire schedule (hereinafter, simply referred to as a “schedule”) of a project such as system operation work and production management.

As illustrated in FIG. 1, a schedule planning device 1 functionally includes a work data acquisition unit 2, a schedule planning unit 3, a data storage unit 4, and a schedule display unit 5. In the schedule planning device 1, the schedule planning unit 3 is functionally connected to each of the work data acquisition unit 2, the data storage unit 4, and the schedule display unit 5.

### Work Data Acquisition Unit

The work data acquisition unit 2 detects an operation on the schedule planning device 1 by a user of the schedule planning device 1, that is, a person who plans (creates) the schedule, and acquires setting information of various periodic works included in the schedule input by the operation. The “periodic work” described herein is, for example, a predetermined work performed N times (N=1, 2, . . . ) during a period such as one day, one week, one month, or one year, and includes, for example, a maintenance work, a security check work, and the like. Note that the setting information of the periodic work input by a planner of the schedule includes, for example, various types of data such as a work type (for example, daily, weekly, monthly, yearly, and the like), the period, an execution interval, and an execution date (day of the week).

In addition, in a case where a change (update) operation is performed on an already created schedule by the planner of the schedule, the work data acquisition unit 2 acquires change (update) information of the operation. Note that the change information acquired by the work data acquisition unit 2 includes, for example, not only change information on a work period but also information on absence of a worker and the like and change information on a worker in charge.

### Schedule Planning Unit

The schedule planning unit 3 performs various processing for automatically planning (creating and changing) a schedule according to information input by the planner on the basis of the setting information and change information of the periodic work acquired by the work data acquisition unit 2 (information on the work to be assigned) and various data stored in the data storage unit 4.

As illustrated in FIG. 1, the schedule planning unit 3 functionally includes a schedule creation/change unit 31 (schedule planning unit), a phase setting unit 32, and a schedule display control unit 33.

In a case where acquiring new periodic work setting information from the work data acquisition unit 2, the schedule creation/change unit 31 automatically creates the schedule according to the information input by the planner on the basis of the periodic work setting information and the various data stored in the data storage unit 4. Further, in a case where acquiring schedule change information from the work data acquisition unit 2, the schedule creation/change unit 31 automatically changes (updates) the schedule on the basis of the change information.

Note that, in schedule planning (creating and changing) processing, the schedule creation/change unit 31 sets assignment of works to workers, and also sets a scheduled execution time (hereinafter referred to as “scheduled work time”) of an assigned work according to skills (ability, performance, and the like) of the worker. Then, the schedule creation/change unit 31 stores data of the created or changed (updated) schedule in the data storage unit 4.

The phase setting unit 32 performs setting processing of a schedule creation mode (hereinafter referred to as a “creation phase”) on the basis of the setting information or the change (update) information of the periodic work acquired by the work data acquisition unit 2 and the various data stored in the data storage unit 4. In the present embodiment, as the schedule creation phase, a creation phase referred to as a “normal phase” and a creation phase referred to as a “human resource development phase” are provided.

The normal phase (a first creation phase) is the schedule creation phase mainly for the purpose of improving productivity and work efficiency. In the normal phase, in consideration of the skill (ability) of the worker for the periodic work, basically, the periodic work is preferentially assigned to a highly skilled worker to plan (create and change) the schedule.

On the other hand, the human resource development phase (a second creation phase) is the schedule creation phase for the purpose of improving the skill (ability) of the worker, that is, human resource development. In the human resource development phase, the periodic work is preferentially assigned to an inexperienced (a low-skilled) worker to plan (create and change) the schedule.

In the present embodiment, the schedule in the human resource development phase is planned (created and changed) only in a case where there is a margin in a work situation and the inexperienced (low-skilled) worker is included among workers who can take charge of the work to be assigned. Specifically, the schedule in the human resource development phase is planned (created and changed) only in a case where there is a margin in the work situation and a worker having an experience value less than a predetermined experience value (for example, “3”) is included among the workers. On the other hand, for example, in a case where there is no margin in the work situation or when the worker (low-skilled worker) having an experience value less than the predetermined experience value (for example, “3”) is not included among the workers who can take charge of the work to be assigned, the schedule in the normal phase is planned.

Note that “in a case where there is a margin in the work situation” is, for example, when schedule progress or deadline is not delayed even if a predetermined work is assigned to the inexperienced (low-skilled) worker. More specifically, in a case where work of all workers who can be in charge of the predetermined work has been completed within regular working hours in a latest predetermined period, that is, in a case where overtime work has not occurred (in a case where there is a margin in work time), in a case where there is a worker to whom the work has not been assigned over a period in which the predetermined work is to be performed (in a case where there is a margin in personnel), and the like correspond to “in a case where there is a margin in the work situation”. In the present embodiment, the phase setting unit 32 refers to a work record data group 43 to be described later stored in the data storage unit 4, and determines whether there is a margin in the work situation on the basis of whether or not the former case has occurred (information indicating whether or not there is a margin in the work situation).

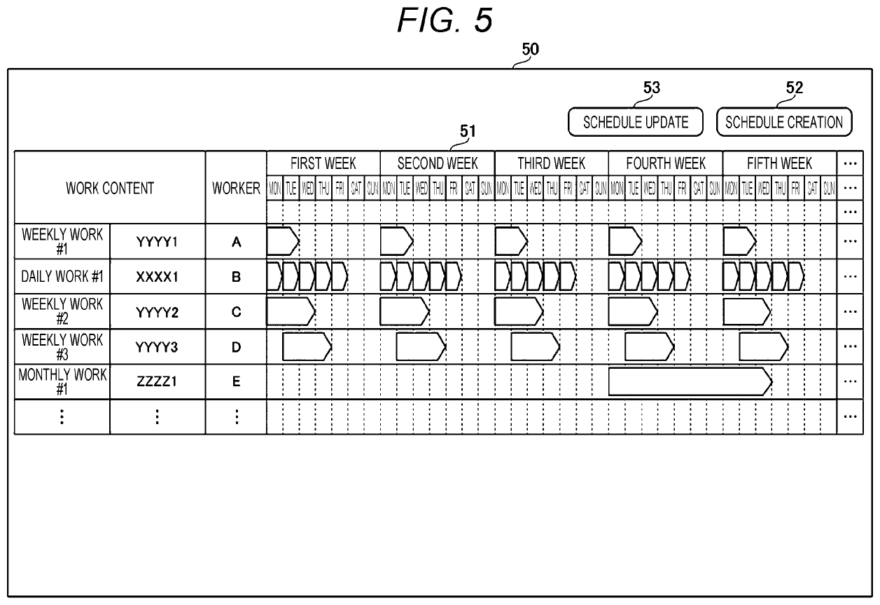

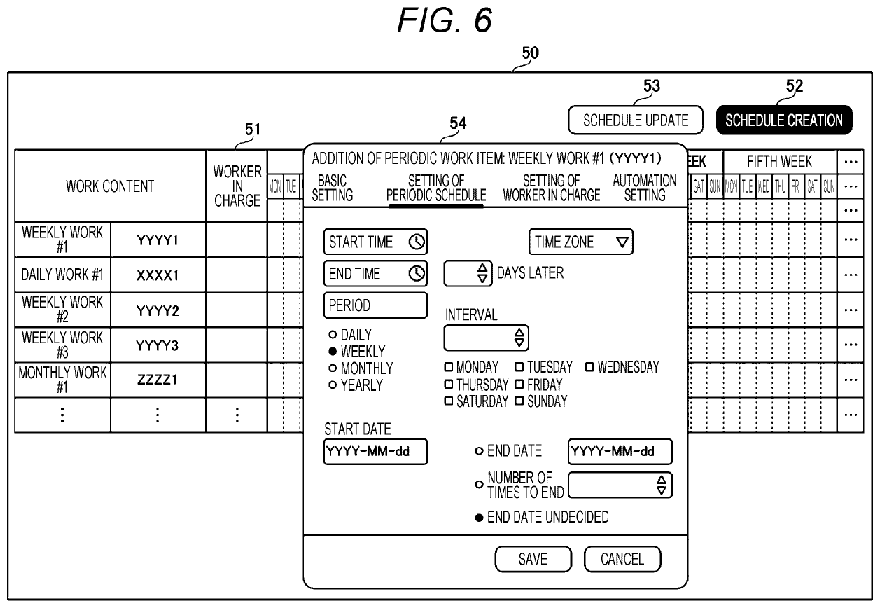

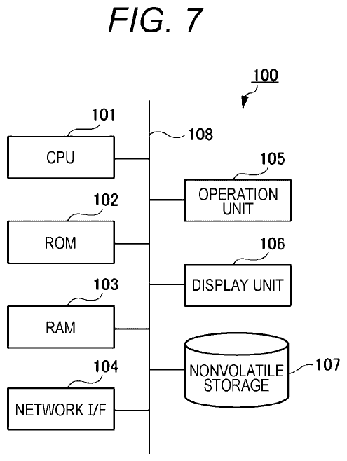

The schedule display control unit 33 controls display processing of various types of information in the schedule display unit 5. For example, the schedule display control unit 33 performs control for displaying, on the schedule display unit 5, an input screen (see FIG. 6 to be described later) for the planner of the schedule to input setting information and change (update) information of the periodic work via an operation unit 105 to be described later (see FIG. 7 to be described later). Further, for example, the schedule display control unit 33 performs control for displaying, on the schedule display unit 5, an image (see FIG. 5 described later) of the schedule created or changed (updated) by the schedule creation/change unit 31.

### Data Storage Unit

The data storage unit 4 stores various types of data necessary for schedule planning (creating and changing) processing by the schedule creation/change unit 31. Specifically, as illustrated in FIG. 1, the data storage unit 4 stores a worker schedule data group 41, a work skill data group 42 (skill information), and the work record data group 43.

The worker schedule data group 41 includes schedule data for each worker (hereinafter referred to as “worker schedule data”). The work skill data group 42 includes skill data of each worker for the work (hereinafter referred to as “work skill data”) created for each work type (work content). The work record data group 43 includes work record data of each worker in a predetermined period in the past. Note that the work record data of each worker includes information such as a work execution date, a work start time, a work end time, and the work type.

In addition, the data storage unit 4 stores schedule data 44 created or updated by the schedule creation/change unit 31. Note that the schedule data 44 may include not only data of the latest schedule but also data of the schedule created and changed (updated) within a past specific period, that is, update history data of the schedule.

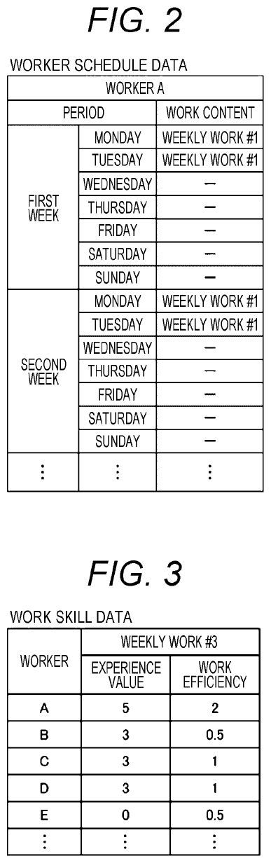

FIG. 2 is a diagram illustrating a configuration of the worker schedule data included in the worker schedule data group 41. Note that FIG. 2 illustrates a configuration of the worker schedule data of a worker A as an example, however, the worker schedule data of other workers (a worker B to a worker E to be described later and the like) has a similar configuration.

As illustrated in FIG. 2, the worker schedule data has a configuration in a table form, and the work content (work type) assigned to each worker for each day after start date of the project is defined. In the example illustrated in FIG. 2, a work referred to as “weekly work #1” is assigned to the worker A on Monday and Tuesday of a first week, Monday and Tuesday of a second week, and the like after start of the project.

FIG. 3 is a diagram illustrating a configuration of the work skill data included in the work skill data group 42. Note that FIG. 3 illustrates, as an example, the work skill data of the work (work type) referred to as “weekly work #3”, but the work skill data of other works (work types) has a similar configuration.

As illustrated in FIG. 3, the work skill data has a configuration in a table form, and various types of data (hereinafter referred to as “skill parameter”) related to skills (ability and performance) for the work are defined for each worker (WORKER A to WORKER E in the figure, and the like). In the example illustrated in FIG. 3, an example in which a skill parameter referred to as “experience value” and a skill parameter referred to as “work efficiency” are defined as skill parameters will be described. Note that the experience value is the number of times the work has been completed within the scheduled work time among the latest five times when a target work has been actually performed. Therefore, the maximum value of the experience value is “5”, and the minimum value of the experience value is “0”. In addition, the work efficiency is an average value of values obtained by dividing the scheduled work time by an actual work time in the latest five times when the target work has been actually performed.

Note that the scheduled work time for the target work is a time set according to the work efficiency of the worker, and the scheduled work time is set shorter as the work efficiency of the worker for the target work increases. That is, in the present embodiment, when the worker gains experience and the work efficiency for the target work increases, the scheduled work time of the target work set to the worker is also set to be short accordingly. However, the present invention is not limited thereto, and a common scheduled work time may be set as the scheduled work time for the target work regardless of the work efficiency (skill) of the worker.

In the example illustrated in FIG. 3, the worker having the highest skill for the weekly work #3 is the worker A, and the experience value and the work efficiency are respectively “5” and “2”. On the other hand, in the example illustrated in FIG. 3, the worker having the lowest skill for the weekly work #3 is the worker E, and the experience value and the work efficiency are respectively “0” and “0.5”. Note that the skill parameter defined in the skill data of the worker for the target work is not limited to the example illustrated in FIG. 3, and other skill parameters (for example, working years and the like) may be defined.

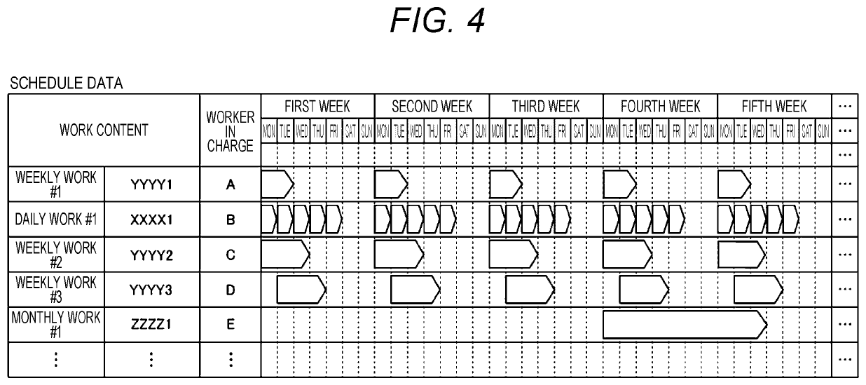

FIG. 4 is a diagram illustrating a configuration of the schedule data 44 of the project stored in the data storage unit 4. The schedule data 44 is created and changed (updated) based on the worker schedule data (see FIG. 2) and the work skill data (see FIG. 3) stored in the data storage unit 4. Note that in FIG. 4, in order to clarify the configuration of the schedule data 44, the schedule data 44 is illustrated in a form of a Gantt chart, but actually, the schedule data 44 is stored in the data storage unit 4 in a table form.

As illustrated in FIG. 4, in the schedule data 44, a worker in charge, and a work period of the worker in charge after the start date of the project are defined for each work content (work type). Note that in FIG. 4, the work period of each worker in charge is indicated by a length of a bar graph (white pentagonal mark in the figure) extending in a progressing direction (a direction from a first week to a fifth week) of the work period in the figure. Then, the work period of the worker in charge is determined based on the skill data (see FIG. 3) of the worker in charge for the target work.

In the schedule data 44 illustrated in FIG. 4, the weekly work #1 (name “YYYY1”) is assigned to the worker A, and it is specified that the worker A performs the weekly work #1 once in a period of Monday and Tuesday of each week (the first week to the fifth week, and the like). In the example illustrated in FIG. 4, it is specified that the daily work #1 (name “XXXX1”) is assigned to the worker B, and the worker B performs the daily work #1 every day in a period of Monday to Friday of each week (the first week to the fifth week, and the like). In the example illustrated in FIG. 4, the weekly work #2 (name “YYYY2”) is assigned to the worker C, and it is specified that the worker C performs the weekly work #2 once in a period of Monday to Wednesday of each week (the first week to the fifth week, and the like). In the example illustrated in FIG. 4, the weekly work #3 (name “YYYY3”) is assigned to the worker D, and it is specified that the worker D performs the weekly work #3 once in a period of Tuesday to Thursday of each week (the first week to the fifth week, and the like). Further, in the example illustrated in FIG. 4, it is specified that the monthly work #1 (name “ZZZZ1”) is assigned to the worker E, and the worker E performs the monthly work #1 once, for example, in a period from Monday of the fourth week to Wednesday of the fifth week.

### Schedule Display Unit

The schedule display unit 5 displays various data stored in the data storage unit 4. In addition, the schedule display unit 5 has a graphical user interface (GUI) function, and can reflect a user's operation on the operation unit 105 to be described later (see FIG. 7 described later) on a display screen of the schedule display unit 5. Therefore, in the present embodiment, an operation when the planner of the schedule creates and updates the schedule is also reflected on the display screen of the schedule display unit 5.

FIG. 5 is a diagram illustrating an example of a display mode of the schedule data 44 planned by the schedule planning unit 3 on a display screen 50 of the schedule display unit 5. In this example, an image (a Gantt chart) of a schedule 51 corresponding to the schedule data 44 (see FIG. 5) is displayed on the display screen 50. In addition, in the display screen 50, an image of a schedule creation button 52 and an image of a schedule update button 53 respectively operated (clicked or the like) by the planner of the schedule at the time of creating and updating the schedule are displayed in an upper portion of the schedule 51.

In the present embodiment, when the planner of the schedule inputs the setting information and the change (update) information of the periodic work in the schedule, the planner first performs a selection operation (click or the like) of the work (for example, the weekly work #1 or the like) to be set or changed on the display screen 50. Next, when the planner operates (clicks or the like) the schedule creation button 52 or the schedule update button 53, an information input screen that allows input of the setting information or the change information for the work is displayed superimposed on the image of the schedule 51. Then, when the planner inputs the setting information or the change information of the periodic work via the information input screen, the schedule 51 is automatically generated or changed (updated).

FIG. 6 is a diagram illustrating an example of a display mode of an information input screen 54 in a case where the schedule creation button 52 is operated (clicked or the like) by the planner when creating the schedule 51 on the display screen 50 of the schedule display unit 5. Note that FIG. 6 illustrates a display example of the information input screen 54 in a case where the schedule creation button 52 is operated after the weekly work #1 is selected by the planner at the start of creation of the schedule 51. Further, the example illustrated in FIG. 6 is a display mode example at the start of new creation of the schedule 51, and for example, information such as the worker in charge, the work assigned to each worker in charge, and the scheduled work time is not set in the schedule 51.

On the information input screen 54 illustrated in FIG. 6, it is possible to switch and display each of setting pages referred to as “basic setting”, “periodic schedule setting”, “person in charge setting”, and “automation setting” of the weekly work #1 by an operation of the planner of the schedule. On the “periodic schedule setting” page of the weekly work #1, as illustrated in FIG. 6, for example, start time and end date and time of the weekly work #1 (“END TIME” and “* DAYS LATER” in the figure), time zone, execution interval of the weekly work #1 (“INTERVAL” in the figure), type of the weekly work #1 (“DAILY”, “WEEKLY”, “MONTHLY”, and “YEARLY” in the figure), execution day of the weekly work #1 (“MONDAY” to “SUNDAY” in the figure), start date of the weekly work #1, end condition of the weekly work #1 (“END DATE”, “NUMBER OF TIMES TO END”, and “END DATE UNDECIDED” in the figure), and the like can be set. Note that, although not illustrated here, the information input screen displayed when the schedule update button 53 is operated is configured so that change (update) information (for example, information that the person in charge is undecided, a period during which the person in charge is undecided, and the like) can be input for the work to be changed by the operation of the planner.

### Hardware Configuration of Schedule Planning Device

The schedule planning device 1 of the present embodiment can be constituted by an information processing device such as a computer device having a calculation function and a communication function. FIG. 7 is a block diagram illustrating an example of a hardware configuration of a computer device 100 applicable as the schedule planning device 1.

The computer device 100 includes a central processing unit (CPU) 101, a read only memory (ROM) 102, and a random access memory (RAM) 103 connected to a bus line 108. In addition, the computer device 100 includes a network interface (I/F) 104, the operation unit 105, a display unit 106, and a nonvolatile storage 107 connected to the bus line 108. Note that although not illustrated in FIG. 7, the computer device 100 also includes various interfaces used when input/output processing of various data (various information) is performed with an external device.

The CPU 101 reads a program code of software for realizing various processing functions included in the schedule planning device 1 from the ROM 102 to the RAM 103 and executes the program code. At this time, variables, parameters, and the like generated during arithmetic processing are also temporarily written in the RAM 103. That is, the schedule planning unit 3 (see FIG. 1) included in the schedule planning device 1 is included in the CPU 101. Further, the data storage unit 4 (see FIG. 1) included in the schedule planning device 1 is included in the RAM 103.

The network I/F 104 includes, for example, a network interface card (NIC) or the like, and transmits and receives various data to and from each device connected via wireless communication.

The operation unit 105 includes, for example, a key, a button, and the like, generates an operation signal corresponding to an operation content input by the user, and supplies the operation signal to the CPU 101. The display unit 106 includes, for example, a liquid crystal panel or the like, and displays characters, images, and the like on a screen. In addition, the display unit 106 may include a touch panel, and in this case, the display unit 106 and the operation unit 105 are integrally configured. Note that the work data acquisition unit 2 and the schedule display unit 5 (see FIG. 1) included in the schedule planning device 1 are respectively included in the operation unit 105 and the display unit 106.

The nonvolatile storage 107 can be configured by, for example, a hard disk drive (HDD), a solid state drive (SSD), a flexible disk, an optical disk, a magneto-optical disk, a CD-ROM, a CD-R, a magnetic tape, a nonvolatile memory, or the like. The nonvolatile storage 107 stores various programs for causing the computer device 100 to function as the schedule planning device 1 in addition to an operating system (OS) and various parameters. Note that information (data) such as a program, a table, and a file for realizing each function included in the schedule planning device 1 may be stored in, for example, a recording medium such as an IC card, an SD card, and a DVD in addition to the ROM 102 and the nonvolatile storage 107.

### Outline of Schedule Planning/Update Processing

In the present embodiment, as described above, the normal phase and the human resource development phase are provided as the schedule creation phase of the project. Then, in the normal phase, as described above, in consideration of the skill (ability and performance) of each worker for the periodic predetermined work, basically, the predetermined work is preferentially assigned to the skilled worker to create or change (update) the schedule. On the other hand, in the human resource development phase, the predetermined work is preferentially assigned to the inexperienced (low-skilled) worker, and the schedule is created or changed (updated) for the purpose of improving the skill of the worker.

Here, in order to facilitate understanding of content (principle) of schedule planning/update processing in the schedule planning device 1 of the present embodiment, a case where the following situation occurs will be described as an example. First, consider a case where a situation, in which the weekly work #3 by the worker D cannot be performed due to absence of the worker D or the like, occurs in the second week of the schedule illustrated in FIG. 4. Note that in this example, it is assumed that information such as absence of the worker D is obtained before the second week. Further, in this example, a case where the skill data of each worker for the weekly work #3 is the work skill data illustrated in FIG. 3 will be considered.

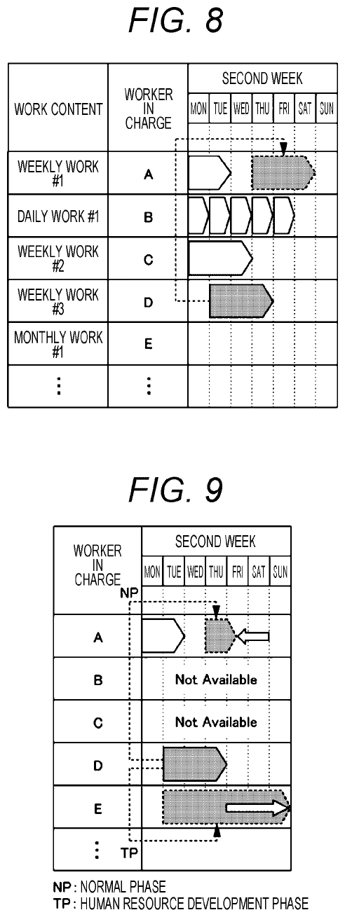

In a case where such a situation occurs, in the conventional schedule planning device, the weekly work #3 is assigned to the worker having a highest work efficiency among the workers who can be in charge of the weekly work #3 instead of the worker D. FIG. 8 is a diagram illustrating an assignment change mode of the weekly work #3 in the second week when the above situation occurs in the conventional schedule planning device. In the conventional schedule planning device, as indicated by a broken arrow in FIG. 8, the weekly work #3 in the second week is assigned to the worker A having the highest work efficiency (see FIG. 3) among the workers (the worker A, the worker C, and the worker E) who can be in charge of the weekly work #3 instead of the worker D.

On the other hand, in the schedule planning device 1 of the present embodiment, in a case where the above situation occurs, the schedule is planned (changed) as follows. FIG. 9 is a diagram illustrating an assignment change mode of the weekly work #3 in the second week in the schedule planning device 1 of the present embodiment when the above situation occurs.

In the present embodiment, first, in consideration of the skill data of each worker for the weekly work #3 illustrated in FIG. 3, workers who can be assigned (in charge of) the weekly work #3 instead of the worker D are extracted. At this time, based on the work efficiency of each worker for the weekly work #3 illustrated in FIG. 3 and a period in which there is no work by each worker in the second week (hereinafter, referred to as a “work idle period”), a worker who can perform the weekly work #3 in the work idle period is extracted. In this example, the worker A, the worker C, and the worker E are extracted as the workers who can be assigned the weekly work #3 in the second week instead of the worker D. Note that for the worker B, although Saturday and Sunday of the second week are work idle periods, the work efficiency of the worker B for the weekly work #3 is lower than that of the worker D, and the weekly work #3 cannot be completed in two days of Saturday and Sunday, and thus it is determined that the worker B is not available (“Not Available” in FIG. 9).

Next, in the present embodiment, the schedule creation phase is determined (set). Specifically, in a case where there is a margin in the work situation and the worker (low-skilled worker) having an experience value less than the predetermined experience value (for example, “3”) are included among the workers who can be assigned the weekly work #3, the human resource development phase is set as the creation phase. On the other hand, for example, in a case where there is no margin in the work situation or in a case where the worker having an experience value less than the predetermined experience value (for example, “3”) are not included among the workers who can be assigned the weekly work #3, the normal phase is set as the creation phase.

Note that, in the present embodiment, as described above, for example, in a case where the work of all the workers who can take charge of the work to be assigned has been completed within the regular working hours (in a case where overtime work has not occurred) in the latest predetermined period, it is determined that there is a margin in the work situation. Then, in the example illustrated in FIG. 9, since there is the worker E with a low experience value (less than “3”) among the workers who can be assigned the weekly work #3, the normal phase is set as the creation phase only in a case where there is no margin in the work situation.

Then, in the normal phase, the weekly work #3 is assigned to the worker having the highest work efficiency, in this example, the worker A (see FIG. 3) from among the extracted workers (the worker A, the worker C, and the worker E) (see a broken arrow NP in FIG. 9). Further, at this time, in the present embodiment, the scheduled work time of the weekly work #3 newly assigned to the worker A is also changed according to the work efficiency of the worker A. In the example illustrated in FIG. 9, since the work efficiency of the worker A is twice that of the worker D (see FIG. 3), the scheduled work time of the weekly work #3 newly assigned to the worker A is one and a half days.

On the other hand, in the human resource development phase, the weekly work #3 is assigned to the worker having the lowest work efficiency, in this example, the worker E (see FIG. 3) from among the extracted workers (the worker A, the worker C, and the worker E) (see a broken line arrow TP in FIG. 9). Further, at this time, in the present embodiment, the scheduled work time of the weekly work #3 newly assigned to the worker E is also changed according to the work efficiency of the worker E. In the example illustrated in FIG. 9, since the work efficiency of the worker E is half that of the worker D (see FIG. 3), the scheduled work time of the weekly work #3 newly assigned to the worker E is six days.

Note that since the work efficiency of the worker C is lower than that of the worker A and higher than that of the worker E (see FIG. 3), it is determined that the worker C is not available (“Not Available” in FIG. 9) in both the normal phase and the human resource development phase.

In the example illustrated in FIG. 9, although a processing example in a case where the schedule once created by the schedule planning device 1 is changed (updated) has been described, even when the schedule is newly created or the like, the schedule is created in a mode in which both the normal phase and the human resource development phase are used according to the above-described method.

### Processing Flow of Schedule Planning Processing

Next, a specific processing flow of various types of processing at the time of schedule planning performed by the schedule planning device 1 will be described with reference to the drawings.

### Schedule Planning Processing

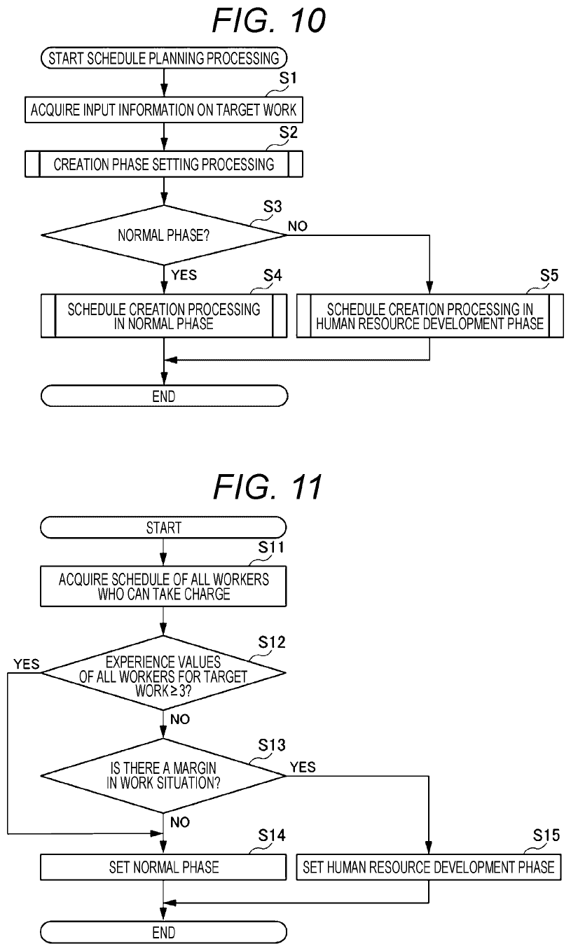

FIG. 10 is a flowchart illustrating a procedure of the schedule planning processing performed by the schedule planning unit 3 of the schedule planning device 1. Note that the schedule planning processing illustrated in FIG. 10 is performed on software by the CPU 101 in FIG. 7. In addition, the schedule planning processing illustrated in FIG. 10 is started every time the user (planner) of the schedule planning device 1 performs an input operation of various types of information of the periodic work (hereinafter referred to as “target work”) to be set or changed.

First, the schedule planning unit 3 acquires input information on the target work via the work data acquisition unit 2 (S1). In this processing, when the schedule is newly created, the setting information (work type, period, and the like) of the target work input by the user (planner) via the operation unit 105 (see FIG. 2 described later) is acquired as the input information on the target work. In addition, in this processing, when the schedule is changed (updated), the change (update) information of the target work input by the user is acquired as the input information on the target work.

Next, the schedule planning unit 3 (phase setting unit 32) performs the schedule creation phase setting processing (S2). In this processing, the schedule planning unit 3 (phase setting unit 32) sets the creation phase to one of the normal phase and the human resource development phase according to experience values (see FIG. 3) of all workers who can be assigned the target work and whether or not there is a margin in the work situation. Note that details of the schedule creation phase setting processing will be described later with reference to FIG. 11 described later.

Next, the schedule planning unit 3 (phase setting unit 32) determines whether the schedule creation phase is the normal phase (S3). This determination processing is performed on the basis of setting results of the creation phase in processing of S2. Then, in a case where the normal phase is set as the creation phase in the processing of S2, a determination result of S3 is YES determination, and in a case where the human resource development phase is set as the creation phase in the processing of S2, the determination result of S3 is NO determination.

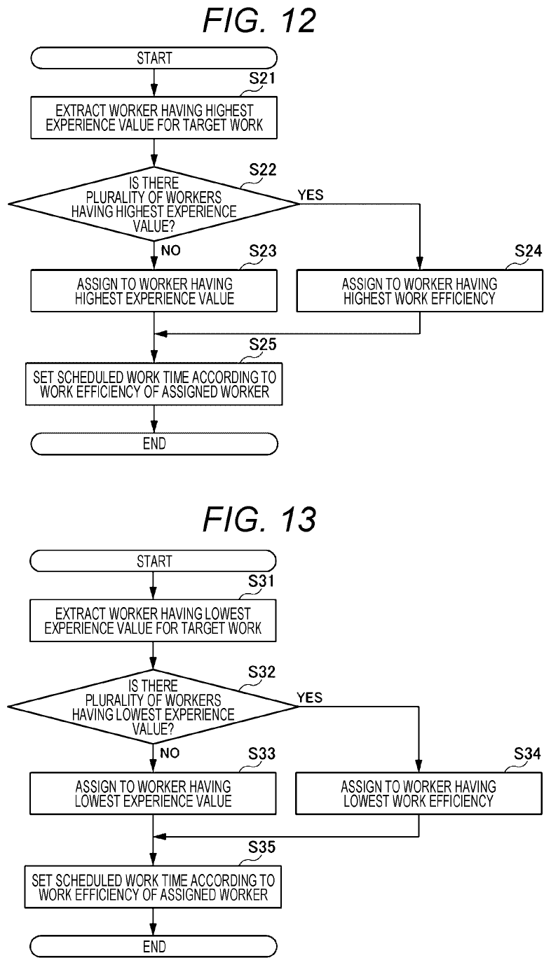

In a case where the schedule planning unit 3 determines that the creation phase is the normal phase in S3 (In a case of YES determination in S3), the schedule planning unit 3 (schedule creation/change unit 31) performs schedule creation processing in the normal phase (S4). In this processing, the schedule planning unit 3 creates or changes the schedule by assigning the target work to a worker having higher skill on the basis of the skill data (see FIG. 3) for each work of the target work. Note that details of the schedule creation processing in the normal phase will be described later with reference to FIG. 12 described later. Then, after processing of S4, the schedule planning unit 3 ends the schedule planning processing.

On the other hand, in a case where the schedule planning unit 3 determines that the creation phase is not the normal phase in S3 (in a case of NO determination in S3), the schedule planning unit 3 (schedule creation/change unit 31) performs the schedule creation processing in the human resource development phase (S5). In this processing, the schedule planning unit 3 creates or changes the schedule by assigning the target work to a worker having lower skill on the basis of the skill data (see FIG. 3) for each work of the target work. Note that details of the schedule creation processing in the human resource development phase will be described later with reference to FIG. 13 described later. Then, after processing of S5, the schedule planning unit 3 ends the schedule planning processing.

### Creation Phase Setting Processing

Next, the schedule creation phase setting processing performed in the processing of S2 during the schedule planning processing (see FIG. 10) will be described with reference to FIG. 11. FIG. 11 is a flowchart illustrating a procedure of the schedule creation phase setting processing. Note that the creation phase setting processing illustrated in FIG. 11 is performed on software by the CPU 101 in FIG. 7.

First, the schedule planning unit 3 (phase setting unit 32) acquires the schedules of all the workers who can be in charge of (assigned) the target work at a current processing time point (S11). In this processing, the schedule planning unit 3 acquires the schedule data (see FIG. 2) for each worker of all the workers who can be in charge of the target work stored in the data storage unit 4.

Next, the schedule planning unit 3 (phase setting unit 32) determines whether the experience values for the target work of all the workers who can be in charge of the target work are “3” or more (S12). In this determination processing, in a case where the worker having an experience value for the target work less than “3” is included in all the workers who can be in charge of the target work, a determination result in S12 is NO determination, and in a case where the worker having an experience value for the target work less than “3” is not included, the determination result in S12 is YES determination. Note that this determination processing is performed on the basis of the skill data (see FIG. 3) for each work of the target work. Further, here, an example in which a threshold of the experience value serving as a trigger for switching the creation phase is “3” is described, however, the threshold of the experience value may be another value (for example, “2” or “4”).

In S12, in a case where the schedule planning unit 3 determines that the experience values for the target work of all the workers who can be in charge of the target work are “3” or more (in a case of YES determination in S12), the schedule planning unit 3 (phase setting unit 32) performs processing of S14 described later.

On the other hand, in a case where the schedule planning unit 3 determines in S12 that the experience values for the target work of all the workers who can be in charge of the target work are not “3” or more (in a case of NO determination in S12), the schedule planning unit 3 (phase setting unit 32) determines whether there is a margin in the work situation (S13). In this processing, the schedule planning unit 3 refers to the work record data group 43 stored in the data storage unit 4, and determines whether the work of all the workers who can be in charge of the target work has been completed within the regular working hours (overtime work has not occurred) in the latest predetermined period. Then, in a case where the work of all the workers who can be in charge of the target work has been completed within the regular working hours, the schedule planning unit 3 determines that there is a margin in the work situation (YES determination), and otherwise determines that there is no margin in the work situation (NO determination).

In a case where the schedule planning unit 3 determines that there is no margin for the work situation in S13 (In a case of NO determination in S13) or in a case of YES determination in S12, the schedule planning unit 3 (phase setting unit 32) sets the normal phase as the schedule creation phase (S14). Note that information on the schedule creation phase is stored in, for example, the data storage unit 4 (see FIG. 1). Then, after the processing of S14, the schedule planning unit 3 ends the creation phase setting processing and returns the processing to processing of S3 during the schedule planning processing (see FIG. 10).

On the other hand, in a case where the schedule planning unit 3 determines in S13 that there is a margin in the work situation (in a case of YES determination in S13), the schedule planning unit 3 (phase setting unit 32) sets the human resource development phase as the schedule creation phase (S15). Then, after processing of S15, the schedule planning unit 3 ends the creation phase setting processing and returns the processing to the processing of S3 during the schedule planning processing (see FIG. 10).

### Schedule Creation Processing in Normal Phase

Next, the schedule creation processing in the normal phase performed in the processing of S4 during the schedule planning processing (see FIG. 10) will be described with reference to FIG. 12. FIG. 12 is a flowchart illustrating a procedure of the schedule creation processing in the normal phase. Note that the schedule creation processing illustrated in FIG. 12 is performed on software by the CPU 101 in FIG. 7.

First, the schedule planning unit 3 (schedule creation/change unit 31) extracts a worker having a highest experience value for the target work (S21). This processing is performed with reference to the work skill data (see FIG. 3) of the target work.

Next, the schedule planning unit 3 (schedule creation/change unit 31) determines whether there are a plurality of extracted workers having the highest experience value (S22).

In a case where the schedule planning unit 3 determines in S22 that there are not a plurality of extracted workers having the highest experience value (In a case of NO determination in S22), the schedule planning unit 3 (phase setting unit 32) assigns the target work to the extracted worker having the highest experience value (S23).

On the other hand, in a case where the schedule planning unit 3 determines in S22 that there are the plurality of extracted workers having the highest experience value (in a case of YES determination in S22), the schedule planning unit 3 (phase setting unit 32) assigns the target work to the worker having the highest work efficiency from among the plurality of workers having the highest experience value (S24). Note that in processing of S24, in a case where there is a plurality of workers having the highest work efficiency, one worker may be randomly selected from the plurality of workers, or one worker may be selected with reference to another condition. In the latter selection method, for example, a worker having a longest work idle time or a worker having a longest working years in a period in which the target work is to be performed may be selected.

After processing of S23 or S24, the schedule planning unit 3 (schedule creation/change unit 31) sets the scheduled work time of the target work according to the work efficiency of the selected worker (S25). In this processing, the scheduled work time of the target work is set shorter as the work efficiency of the selected worker increases. Then, after processing of S25, the schedule planning unit 3 ends the schedule creation processing in the normal phase and also ends the schedule planning processing (see FIG. 10).

### Schedule Creation Processing in Human Resource Development Phase

Next, the schedule creation processing in the human resource development phase performed in the processing of S5 during the schedule planning processing (see FIG. 10) will be described with reference to FIG. 13. FIG. 13 is a flowchart illustrating a procedure of the schedule creation processing in the human resource development phase. Note that the schedule creation processing illustrated in FIG. 13 is performed on software by the CPU 101 in FIG. 7.

First, the schedule planning unit 3 (schedule creation/change unit 31) extracts a worker having a lowest experience value for the target work (S31). This processing is performed with reference to the work skill data (see FIG. 3) of the target work.

Next, the schedule planning unit 3 (schedule creation/change unit 31) determines whether there are a plurality of extracted workers having the lowest experience value (S32).

In a case where the schedule planning unit 3 determines in S32 that there are not a plurality of extracted workers having the lowest experience value (In a case of NO determination in S32), the schedule planning unit 3 (phase setting unit 32) assigns the target work to the extracted worker having the lowest experience value (S33).

On the other hand, in a case where the schedule planning unit 3 determines in S32 that there are the plurality of extracted workers having the lowest experience value (in a case of YES determination in S32), the schedule planning unit 3 (phase setting unit 32) assigns the target work to the worker having the lowest work efficiency from among the plurality of workers having the lowest experience value (S34). Note that in processing of S34, in a case where there is a plurality of workers having the lowest work efficiency, one worker may be randomly selected from the plurality of workers, or one worker may be selected with reference to another condition. In the latter selection method, for example, a worker having the longest working idle time or a worker having a shortest working years in a period in which the target work is to be performed may be selected. In addition, in the latter selection method, for example, whether or not there is work experience in the human resource development phase for the target work may be determined, and a worker having no work experience in the human resource development phase may be selected. In this case, it is possible to give opportunities for skill improvement to more inexperienced workers.

After processing of S33 or S34, the schedule planning unit 3 (schedule creation/change unit 31) sets the scheduled work time of the target work according to the work efficiency of the selected worker (S35). In this processing, the scheduled work time of the target work is set longer as the work efficiency of the worker decreases. Then, after processing of S35, the schedule planning unit 3 ends the schedule creation processing in the human resource development phase and also ends the schedule planning processing (see FIG. 10).

### Various Effects

As described above, in the schedule planning device 1 of the present embodiment, the normal phase focusing on work efficiency and the human resource development phase for the purpose of human resource development (skill improvement) are provided as the schedule creation phase. Then, a schedule of the project is planned (created and changed) in the normal phase or the human resource development phase according to whether or not there is a margin in the work situation, and the skill of each worker for the work to be assigned. Therefore, in the present embodiment, it is possible to plan a schedule that enables not only improvement in productivity and work efficiency but also human resource development. In addition, as a result, a shortage of human resources can be resolved.

In addition, in the schedule planning device 1 of the present embodiment, since the schedule is planned (created and changed) in consideration of the work situation, it is possible to plan an optimal schedule that can flexibly respond to a change in the work situation.

In addition, in the schedule planning device 1 of the present embodiment, the scheduled work time of the work to be assigned is set such that the schedule progress is not delayed according to whether or not there is a margin in the work situation, and the skill of each worker for the work to be assigned. Therefore, in the present embodiment, a highly reliable schedule can be planned.

Further, in the present embodiment, even in a case where there is a margin in the work situation, if the skills of all the workers who can take charge of the work to be assigned are at a predetermined level (experience value is “3”) or higher, the schedule is planned in the normal phase. Therefore, in the present embodiment, it is possible to plan a schedule with higher work efficiency while minimizing work opportunity in the human resource development phase.

Furthermore, in the schedule planning device 1 of the present embodiment, when the planner (user) of the schedule inputs the setting information or the change information of the periodic work via the operation unit 105, the schedule according to the input information is automatically planned. In addition, the input operation of the setting information or the change information of the periodic work by the planner is performed via the information input screen 54 displayed on the display screen 50 of the schedule display unit. Therefore, in the present embodiment, workload of the planner of the schedule can be reduced.

### Various Modifications

Although the schedule planning device 1 according to the embodiment of the present invention has been described above, the present invention is not limited to the above embodiment. A configuration of the present invention can take configurations of various other modifications without departing from the gist of the present invention described in claims.

In the above embodiment, an example has been described in which the worker to whom the work is assigned is determined with reference to both the experience value and the work efficiency of the worker in the schedule creation processing (see FIGS. 12 and 13), but the present invention is not limited thereto. For example, in the schedule creation processing, the worker to whom the work is assigned may be determined with reference to one of the experience value and the work efficiency of the worker. Further, for example, in the schedule creation processing, the worker to whom the target work is to be assigned may be determined with reference to a parameter obtained by adding or integrating the experience value and the work efficiency of the worker. Furthermore, for in the schedule creation processing, each skill parameter may be weighted, and the worker to whom the target work is to be assigned may be determined with reference to each weighted skill parameter.

Further, in the above embodiment, an example (see FIG. 3) in which the experience value and work efficiency are defined as the skill parameters in the skill data of each worker for the target work has been described, but the present invention is not limited thereto. For example, in the schedule creation processing, in a configuration in which the worker to whom the target work is assigned is determined with reference to one of the experience value and the work efficiency of the worker, only one of the experience value and the work efficiency may be defined as the skill parameter in the skill data of each worker for the target work. Further, for example, in the skill data of each worker for the target work, skill parameters (for example, the working years, whether or not there is work experience in the human resource development phase, and the like) other than the experience value and the work efficiency may be defined.

Furthermore, in the above embodiment, an example has been described in which, in the schedule creation phase setting processing (see FIG. 11), whether or not there is a margin in the work situation is determined based on whether the work of all the workers who can take charge of the work to be assigned has been completed within the regular working hours (overtime work has not occurred), however, the present invention is not limited thereto. For example, whether or not there is a margin in the work situation may be determined according to whether there is a worker to whom the work has not been assigned over a period during which the work to be assigned is to be performed, or the determination may be made by combining this condition and conditions in the above embodiment.

In addition, in the above embodiment, an example has been described in which the processing functions of various functional block units included in the schedule planning device 1 are implemented by software, but the present invention is not limited thereto. Some or all of these functional block units may be implemented by hardware.

Note that, in the above embodiment, the above embodiment describes the configuration of the device in detail and specifically in order to describe the present invention in an easy-to-understand manner, and the present invention is not necessarily limited to one including all the described configurations. Positions, sizes, shapes, ranges, and the like of components illustrated in the drawings and the like may not represent actual positions, sizes, shapes, ranges, and the like in order to facilitate understanding of the invention. Therefore, the present invention is not necessarily limited to the positions, sizes, shapes, ranges, and the like disclosed in the drawings and the like. In addition, it is possible to add another component, delete, or replace a component for a part of the configuration of embodiment. In addition, illustrated control lines and information lines indicate what is considered to be necessary for the description, and do not necessarily indicate all the control lines and information lines on a product. In practice, it may be considered that almost all the components are connected to each other.

### REFERENCE SIGNS LIST

1 schedule planning device
2 work data acquisition unit
3 schedule planning unit
4 data storage unit
5 schedule display unit
31 schedule creation/change unit
32 phase setting unit
33 schedule display control unit
41 worker schedule data group
42 work skill data group
43 work record data group
44 schedule data
54 information input screen

1. A schedule planning device comprising:
a phase setting unit capable of setting a schedule creation phase to one of a first creation phase for improving work efficiency and a second creation phase for developing human resources, based on skill information of a plurality of workers for work to be assigned to workers included in a schedule; and
a schedule planning unit that plans the schedule based on information on the work to be assigned input by a user and setting results in the phase setting unit, assigns the work to be assigned to a worker who can take charge of the work to be assigned and has a highest skill for the work to be assigned in a case where the phase setting unit sets the first creation phase, and assigns the work to be assigned to a worker who can take charge of the work to be assigned and has a lowest skill for the work to be assigned in a case where the phase setting unit sets the second creation phase.

2. The schedule planning device according to claim 1, wherein the phase setting unit sets the schedule creation phase based on skill information of the plurality of workers for the work to be assigned and information indicating whether or not there is a margin in a work situation.

3. The schedule planning device according to claim 2, wherein
the phase setting unit is capable of setting the schedule creation phase to the second creation phase in a case where the information indicating whether or not there is a margin in the work situation is information indicating that there is a margin in the work situation, and
the phase setting unit sets the schedule creation phase to the first creation phase in a case where the information indicating whether or not there is a margin in the work situation is information indicating that there is no margin in the work situation.

4. The schedule planning device according to claim 3, wherein
the information indicating whether or not there is a margin in the work situation is information indicating whether work of the plurality of workers is completed within regular working hours in a latest predetermined period, and
in a case where the work of the plurality of workers is completed within the regular working hours, the phase setting unit determines that there is a margin in the work situation.

5. The schedule planning device according to claim 4, wherein
in a state where there is a margin in the work situation,
the phase setting unit sets the schedule creation phase to the first creation phase in a case where all workers who can take charge of the work to be assigned have a skill at a predetermined level or higher, and
the phase setting unit sets the schedule creation phase to the second creation phase in a case where all the workers who can take charge of the work to be assigned do not have the skill at the predetermined level or higher.

6. The schedule planning device according to claim 3, wherein the schedule planning unit determines a scheduled work time of the work to be assigned according to a skill of the worker to whom the work to be assigned is assigned.

7. The schedule planning device according to claim 6, wherein the skill of the worker includes at least one of an experience value and work efficiency for the work to be assigned.

8. The schedule planning device according to claim 3, further comprising a display unit that displays an input screen on which the user can input information on the work to be assigned.
